(19) United States
(12) Patent Application Publication
(10) Pub. No.: US 2008/0197127 A1
(43) Pub. Date: Aug. 21, 2008

(54) MICROWAVE HEATING SYSTEM

(76) Inventors: Alfred Monteleone, Clintondale, NY (US); Brian Weit, Red Hook, NY (US)

Correspondence Address: JOHN MAIER, III, 660 AARON COURT, KINGSTON, NY, 12401-2968, US

(21) Appl. No.: 11/708,624

(22) Filed: Feb. 21, 2007

(51) Int. Cl. H05B 6/80

(52) U.S. Cl. 219/688

(57) ABSTRACT

A heating system is provided for heating a heating media and domestic hot water. The hating system includes an enclosure. A tank is located within the enclosure. A magnetron chamber is located in the enclosure above the tank. At least one heating rod with a hollow interior extends from the magnetron chamber into the lower compartment. The heating rod has a top located in the magnetron chamber and a bottom located in the tank. A heat absorbing media is located within each heating rod. A microwave guide located at the top of each heating rod. A magnetron is mounted on each microwave wave guide. A heating media inlet and a heating media outlet serve for conveying the fluid heating media into and out of the tank.

### BACKGROUND OF THE INVENTION

1. Field of the Invention

This invention relates to heating systems and, more particularly, to a heating system using microwave energy.

2. Prior Art

Microwave energy has in the past been used to provide heat. The most widely known usage of microwave energy is the microwave oven. Microwave energy is clean and efficient. With microwave heat, no heat is lost in flue gases as none exist. An efficient heater utilizing microwave energy for use in both commercial buildings and in residential structures would result in reduced fuel consumption by a clean heating system that is comparatively economical.

### OBJECTS

Accordingly, the objects of this invention are to provide a microwave heating system as follows:
1. That is economical.
2. That is dependable and durable.
3. That is flexible to permit the construction of heating systems of a wide variety of capacities.

### SUMMARY OF THE INVENTION

There is provided a heating system for heating a heating media to be used for heating purposes and also for heating domestic hot water. An enclosure includes a magnetron chamber and a tank with at least one heating rod extending from the magnetron chamber into the tank. A heat absorbing medial is located within the heating rod. Means including a magnetron are used to direct microwave energy into the heat absorbing media.

### BRIEF DESCRIPTION OF THE DRAWINGS

FIG. 1 is a side elevation showing one heating rod within the tank and with the coil for providing domestic hot water wrapped about the one heating rod.

FIG. 2 is a top view of the heating unit with the upper end of the tank removed showing the top of the heating rods.

FIG. 3, which shows the float, is a side elevation of the heating unit with the heating rods and the microwave units omitted.

FIG. 4 is a plan view of the heating rods within the tank and with the coil wrapped about the five heating rod within the tank.

FIG. 5 is a side elevation of the five rods but in a single plane.

FIG. 6 is a schematic view of the electrical circuitry including the tank without the enclosure.

### BRIEF DESCRIPTION OF THE NUMERALS

| NUMERAL | DESCRIPTION |
|---|---|
| 11 | Enclosure |
| 13 | Tank |
| 14 | Lower Part |
| 15 | Magnetron Chamber |
| 16 | Heating Rods |
| 17 | Partition |
| 23 | Upper Section |
| 24 | Lower Section |
| 27 | Heat Absorbing Mixture |
| 29 | Coil |
| 31 | Probes |
| 32 | Coil Inlet |
| 33 | Coil; outlet |
| 34 | Wave Guide |
| 35 | Magnetron |
| 39 | Heating Inlet |
| 41 | Heating Outlet |
| 43 | Thermal coupler |
| 45 | Computer |
| 51 | Electric Supply Line |
| 52 | Electric supply Line |
| 53 | Circuit Breakers |
| 54 | Sixth Circuit Breaker |
| 55 | Capacitor |
| 59 | Fan |

### DETAILED DESCRIPTION OF THE PREFERRED EMBODIMENT

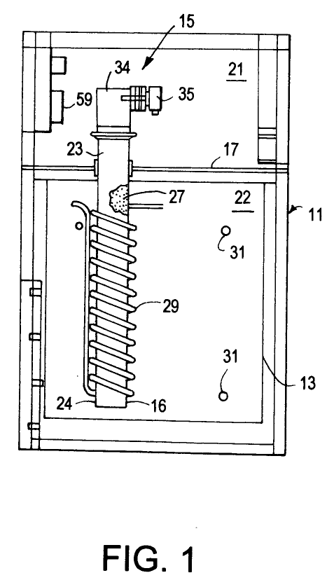

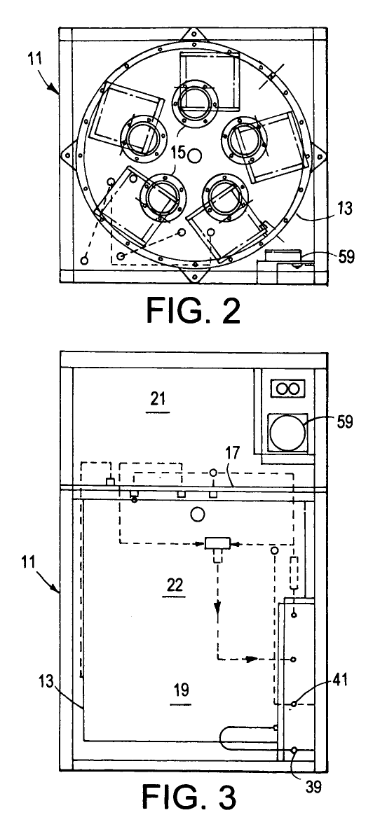

Referring now to FIG. 1, an enclosure 11 is shown with a tank 13 within the enclosure 11 and fills more than half of the enclosure 11. Above the tank 13 and within the enclosure 11 is a magnetron chamber 15. One heating rod 16 is shown in the tank 13 and in the magnetron chamber 15. All of the heating rods 16 are located in the tank 13 and in the magnetron chamber 15 in the same manner as shown. All of the heating rods 16 are generally the same and the description of one heating rod 16 pertains to each heating rod 16 regardless of the number of heating rods 16 being utilized in any one enclosure 11. The tank 13 and the magnetron chamber 15 are separated by a partition 17 which is essentially horizontal. The tank 13, which has a circular cross section, is located below the partition 17. As best seen in FIGS. 2 and 4, a plurality of heating rods 15, namely five rods 15, equally spaced in a circle within the tank 13 and the magnetron chamber 15. Each heating rod 15 has an upper section 23 located in the magnetron chamber 15 with a lower section 24 located in the tank 13.

Each heating rod 16 is hollow and is filled with a heat absorbing mixture 27. The heat absorbing mixture 27 is primarily sand/or silicon and may include a variety of other elements to enhance heat absorption. A coil 29 is wound within the tank 13 around the heating rod 16. The tank 13 is filled with a fluid medial, preferably water or water mixed an additive. The fluid media is used for heating purposes. A pair of temperature probes 31 are mounted in the tank 13. The temperature probes 31 control the temperature of the fluid media. If a pump is used, the pump switch is located in the magnetron chamber 15.

Domestic hot water which is water used for human consumption such as bathing and cooking and which is usually dispersed through a hot water faucet, is heated by passing such water through the coil 29. The domestic hot water does not co-mingle with the fluid media in the lower compartment 23. Domestic hot water is conveyed to the coil 29 through a coil inlet 32 and is conveyed out of the tank 13 through a coil outlet 33.

At the top of each heating rod 15 in the magnetron chamber 15 is a wave guide 33. A magnetron 35 is attached to the side of the wave guide 33. Microwave energy from the magnetron 35 is directed downwardly by its respective wave guide 34. The microwave energy from the magnetron 35 is thereby directed downwardly by the wave guide 34 into the center of the heating rods 16. The microwave energy serves to heat the heat absorbing mixture and thus the heating rods 15 which in turn heat the fluid media in the tank 13 and in the coil 29.

The heating media is supplied into the tank 13 through a heating inlet 39 and is removed through a heating outlet 41. The heating media may be used for any one of many purposes but is usually used for hating purposed.

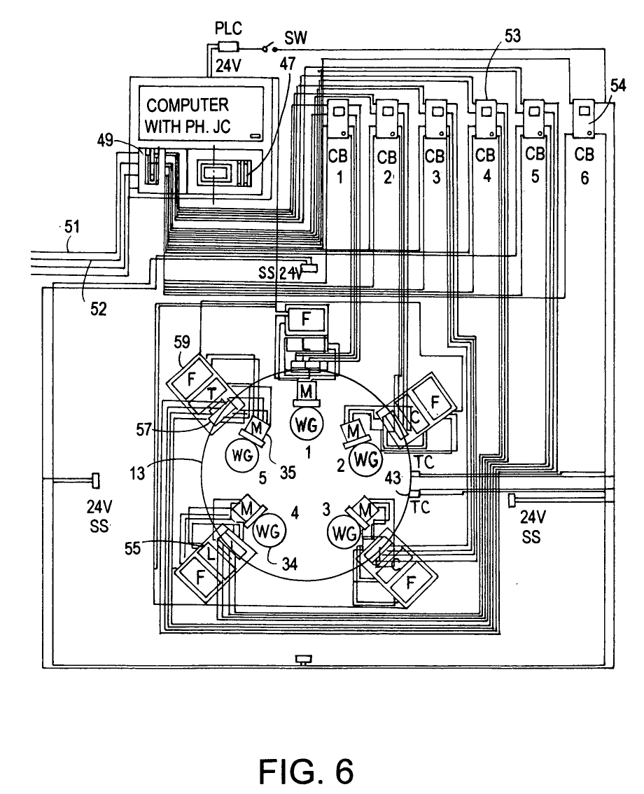

Referring now to FIG. 6, the operating circuit for the five magnetrons 35 and a thermal coupler 43 is shown. A computer 45 is actuated by means of a key pad 47 and a main circuit breaker 49. The voltage supplied is two hundred twenty volts through two electric lines 51,52, each supplying one hundred ten volts. The two electric supply lines 51,52 are connected to each of five circuit breakers 53 and from each such circuit breaker 53 to one of the five magnetrons 35. A sixth circuit breaker 54 is connected to the thermal coupler 43.

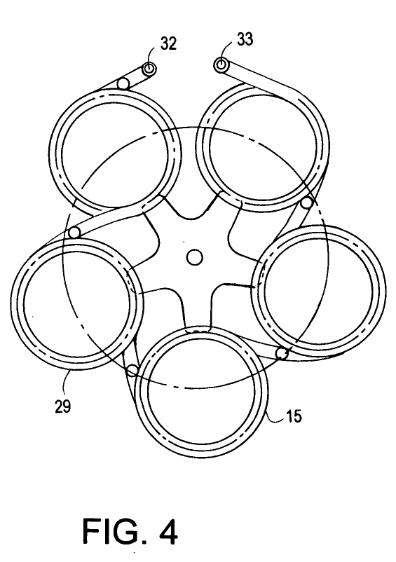

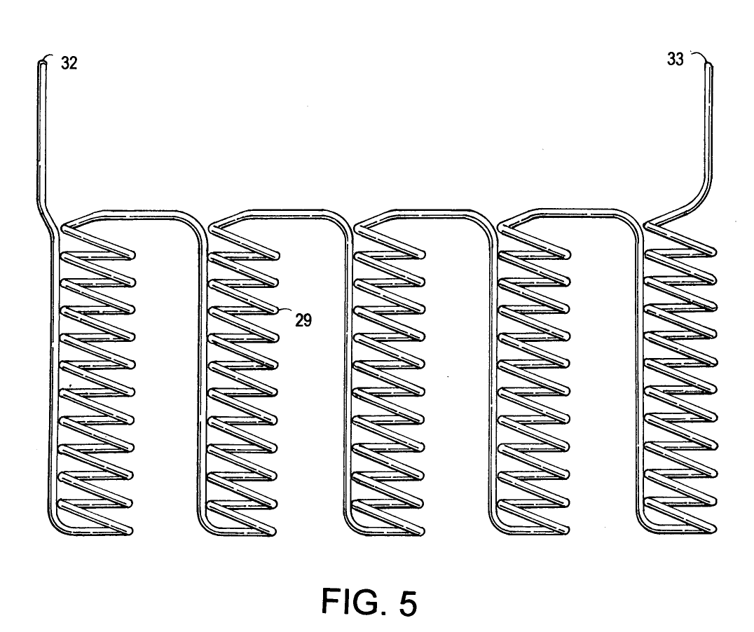

Still referring now to FIG. 6, each of the five coils 29 are shown equally spaced about the tank 13. The wave guide 34, as previously stated, is placed at the top of each heating rod 15 and to the side of each wave guide 34 is the magnetron 35. The magnetron 35 generates microwave energy which the wave guide 34 directs down the hollow center of its respective heating rod 15. A capacitor 55 activates the magnetron 35 through a transformer 57. A fan 59 blows on the capacitor 55 and the transformer 57 for cooling purposes. The fan 59 may also be seen in FIG. 3 located in the upper compartment 21.

While a preferred embodiment is shown and described herein, it should be understood that the present disclosure is made by way of example only and that variations in the described heating system are possible within the scope of this disclosure without departing from the subject matter coming within the scope of the following claims, and a reasonable equivalency thereof, which claims I regard as my invention.

1. A microwave heating system for heating a heating media and domestic hot water, the microwave hating unit comprising:
an enclosure;
a tank and a megaton chamber located within the enclosure;
at least one heating rod extending from the magnetron chamber into the tank, the heating rod including a heat absorbing media within the heating rod;
means including a magnetron located in the magnetron chamber for directing microwave energy into the heat absorbing media;
a heat media inlet and a heat media outlet in the tank for conveying a heating media into and out of the tank.

2. A microwave heating system according to claim 1 wherein the number of heating rods is three.

3. A microwave heating system according to claim 1 wherein the number of heating rods is five.

4. (canceled)

5. A microwave heating system according to claim 1 further including a fan for cooling the magnetron.

6. A microwave heating system according to claim 1 further including a capacitor and a transformer for supplying electrical energy to the magnetron.

7. A microwave heating system according to claim 1 wherein the heat absorbing media is silica.

8. A microwave heating system for heating a heating media and domestic hot water, the microwave microwave heating system comprising:
an enclosure;
a tank located within the enclosure;
a magnetron chamber located within the enclosure above the tank
at least one heating rod with a hollow interior extending from the magnetron into the tank, the heating rod having a top located in the magnetron chamber and a bottom located in the tank;
a heat absorbing media located within each heating rod;
a microwave guide located at the top of each heating rod;
a magnetron mounted on each microwave wave guide;
a heating media inlet and a heating media outlet for conveying the fluid heating media into and out of the lower compartment.

9. A microwave heating system according to claim 8 further including:
a coil for heating the domestic hot water coiled about the heating rod; and
a coil inlet and a coil outlet for conveying domestic hot water into and out of the lower compartment.

10. A microwave heating system according to claim 8 further including a capacitor and a transformer for supplying electrical energy to the magnetron.

11. A microwave heating system according to claim 8 wherein the heat absorbing media is silica.

12. A microwave heating system for heating a fluid heating media and domestic hot water, the heating system comprising:
an enclosure;
a tank located within the enclosure;
a magnetron chamber located above the tank;
a plurality of heating rods with a hollow interior extending from the magnetron chamber into the tank, the heating rod having a top located in the magnetron chamber and a bottom located in the tank;
a heat absorbing media including silicon located within each heating rod;
a microwave guide located at the top of each heating rod;
a magnetron mounted on each microwave wave guides;
a coil for heating domestic hot water coiled about each heating rod;
a coil inlet and a coil outlet for conveying domestic hot water into and out of the lower compartment; and
a heating media inlet and a heating media outlet for conveying the fluid heating media into and out of the lower compartment.
